(19) United States
(12) Patent Application Publication
(10) Pub. No.: US 2004/0034455 A1
(43) Pub. Date: Feb. 19, 2004

(54) Vehicle system and method of communicating between host platform and human machine interface

(76) Inventors: Craig Simonds, Dearborn, MI (US); Vladimir Rasin, Farmington Hills, MI (US); Larry Mitchell, Toronto (CA); Ying Hao, Novi, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/637,418

(22) Filed: Aug. 8, 2003

Related U.S. Application Data
(60) Provisional application No. 60/403,755, filed on Aug. 15, 2002.

(51) Int. Cl. G05D 1/00

(52) U.S. Cl. 701/1

(57) ABSTRACT

A user interfacing electronic system and method are provided for communicating data between a human machine interface and a host platform in a vehicle. The system includes a host platform having application software for executing an application for an electronic device, and a human machine interface for receiving user inputs and providing outputs to a user. A data communication link allows the communication of data between the host platform and the human machine interface. The system further has user interface markup language for communicating messages on the communication link between the host platform and human machine interface, including messages to deliver user inputs and outputs.

### CROSS-REFERENCE TO RELATED APPLICATION

This application claims the benefit of U.S. Provisional Application No. 60/403,755, filed Aug. 15, 2002, the entire disclosure of which is hereby incorporated herein by reference.

### BACKGROUND OF THE INVENTION

The present invention generally relates to the communication of information between a machine and a user in a vehicle and, more particularly, to a vehicle system and method of communicating data between a human machine interface and a host platform in a vehicle, and also the way in which the human machine interface device operates in such an environment.

Automotive vehicles are increasingly being equipped with electronic devices, many of which require a human machine interface (HMI) to allow a user to input data to a machine and to present outputs to the user. One example of a human machine interface includes a visual display with user input keypads, such as a touch-screen display. Visual displays are typically located in the front dash and sometimes also in front of the rear seat in the vehicle to allow users to interface with an infotainment/entertainment system. The user input keypads allow a user to input commands, and the visual display outputs graphics to the user. Another example of a human machine interface includes a voice-based human machine interface employing a microphone to receive spoken audio (voice) inputs and one or more speakers to provide audio (sound) outputs to the user. Human machine interfaces are commonly employed in vehicles to interface with various electronic devices including the audio radio tuner, a compact disc/digital versatile disc (CD/DVD) player, a navigation system, a cell phone, environmental HVAC (heating, ventilation, and air conditioning) controls, and various other host devices.

Many modern in-vehicle infotronic/entertainment systems include an increasing distribution of functional components. In such systems, modules implementing human machine interfaces may have different functionality based on configuration, location, and other circumstances. Using conventional human machine interface architectures, it is becoming increasingly difficult to design a human machine interface module that is flexible enough to address all the anticipated needs of the host devices and users in the vehicle. Additionally, a vehicle may contain several human machine interface devices that operate simultaneously, which complicates the task of executing human machine interface applications. Further, the integration of additional consumer devices into the vehicle makes the application of human machine interfaces even more complicated.

Many of the electronic devices employed in automotive vehicles are typically equipped with a dedicated human machine interface which communicates data between the user and a dedicated host device. Typical human machine interfaces employed in vehicles are designed to provide a particular user interface metaphor, such as, for example, a graphic user interface, for a particular type of application, or require rule engines or scripting engines for handling sophisticated user interface behaviors. As a consequence, conventional human machine interfaces employed in automotive vehicles generally are costly and do not offer the flexibility to handle all anticipated applications. Further, the requirement to provide multiple dedicated human machine interfaces for various devices further adds to the cost and complexity of interfacing with on-board vehicle devices.

It is therefore desirable to provide for a vehicle system and method of communicating data between a human machine interface and a host platform in a vehicle that overcomes the above-mentioned drawbacks associated with prior application dedicated human machine interfaces. In particular, it is desirable to provide for a less costly and more flexible approach for communicating data between a human machine interface and a vehicle host platform, and for implementing the human machine interface module.

### SUMMARY OF THE INVENTION

In accordance with the teachings of the present invention, a vehicle system and method are provided for communicating data between a human machine interface and a host platform in a vehicle. According to one aspect of the present invention, a user interfacing electronics system is provided for use in a vehicle. The system includes a host platform having application software for executing an application for an electronic device. The system also includes a human machine interface for receiving user inputs and providing outputs to a user. A data communication link communicates data between the host platform and the human machine interface. The system further includes user interface markup language for communicating messages via the communication link between the host platform and the human machine interface, including messages to deliver user inputs and outputs with the human machine interface.

According to another aspect of the present invention, a method of communicating data between a human machine interface and a host platform in a vehicle is provided. The method includes the steps of communicating an output message having markup language from a host platform to a human machine interface in a vehicle to provide an output to a user via the human machine interface. The method also includes the step of communicating an input message having markup language from the human machine interface to the host platform to deliver user inputs entered into the human machine interface. The method further includes the step of processing the input and output messages with application software provided in the host platform.

The vehicle system and method of the present invention advantageously provides communication between a human machine interface and a host platform in a vehicle to achieve a reduced cost and increased flexibility user interface.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings.

FIG. 1 is a perspective view of the cockpit of a vehicle equipped with a user interfacing electronic system and human machine interfaces that may communicate data according to the present invention.

FIG. 2 is a block diagram illustrating a vehicle consumer services interface (VCSI) host platform in communication with a plurality of electronic host devices in the vehicle.

FIG. 3 is a block diagram illustrating an application architecture of a human machine interface (HMI) in data communication with a vehicle host platform.

FIG. 4 is a flow diagram illustrating a routine for configuring the application architecture with a new HMI application.

FIG. 5 is a block diagram illustrating the content model HMIAPP according to one example.

FIG. 6 is a block diagram illustrating the content model FORM according to one example.

FIG. 7 is a block diagram illustrating the content model PANEL according to one example.

FIG. 8 is a block diagram illustrating the content model BUTTON according to one example.

FIG. 9 is a block diagram illustrating the content model LISTENER according to one example.

FIG. 10 is a block diagram illustrating the content model VALUESOURCE according to one example.

FIG. 11 is a block diagram illustrating the content model TOGGLEDBUTTON according to one example.

FIG. 12 is a block diagram illustrating the content model LABEL according to one example.

FIG. 13 is a block diagram illustrating the content model LIST according to one example.

FIG. 14 is a block diagram illustrating the content model COMBO according to one example.

FIG. 15 is a block diagram illustrating the content model TABLE according to one example.

FIG. 16 is a block diagram illustrating the content model ROW according to one example.

FIG. 17 is a block diagram illustrating the content model COLUME according to one example.

FIG. 18 is a block diagram illustrating the content model CLOCK according to one example.

FIG. 19 is a block diagram illustrating the content model AUDIOLEVEL according to one example.

FIG. 20 is a block diagram illustrating the content model FANSPEEDINDICATOR according to one example.

FIG. 21 is a block diagram illustrating the content model MESSAGEBOARD according to one example.

FIG. 22 is a block diagram illustrating the content model SPEECHINDICATOR according to one example.

FIG. 23 is a block diagram illustrating the content model CALENDAR according to one example.

FIG. 24 is a block diagram illustrating the content model FORMGROUP according to one example.

FIG. 25 is a block diagram illustrating the content model VUML MESSAGING SPECIFICATION according to one example.

### DETAILED DESCRIPTION OF THE PREFERRED EMBODIMENT

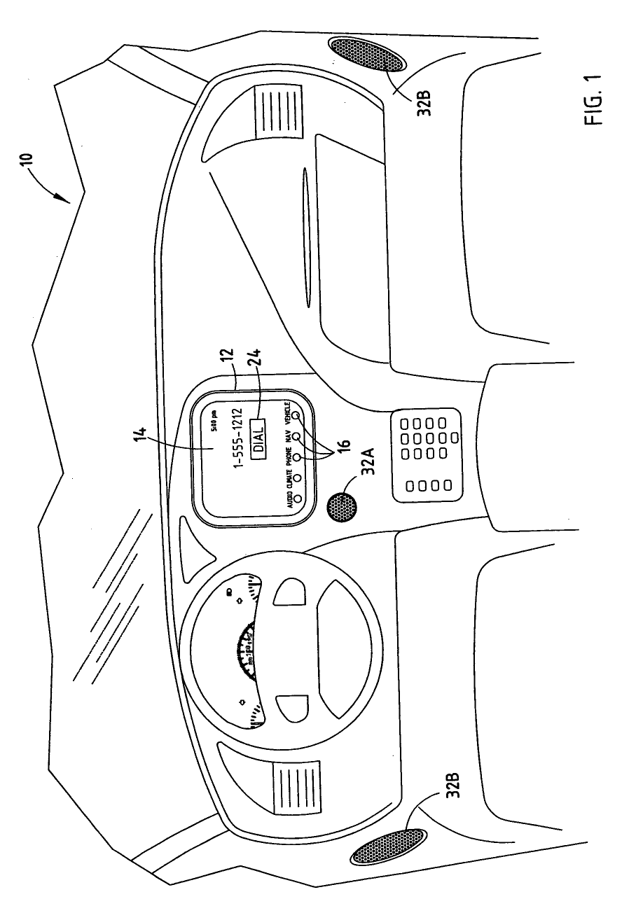

Referring to FIG. 1, the cockpit of a vehicle 10 is generally shown having an electronic system, such as an infotainment/entertainment or telematics system, generally located in the vehicle dash. The electronic system, as shown, includes a main visual human machine interface (HMI) 12 having a touch-screen display 14 that allows passengers in the vehicle to interface with the system to communicate with one or more electronic devices. The touch-screen display 14 may include a conventional display screen for displaying visual images and for providing a plurality of touch-screen inputs, such as the “dial” input button 24 and the following menu inputs 16: audio input, climate input, phone input, navigation input, vehicle input, home input, and work input, according to one example. It should be appreciated that any of various user inputs and visual outputs may be made available on the HMI 12 for inputting and outputting information used for any of a plurality of electronic host devices to allow a user to interface with the electronic host devices (i.e., machines).

Also shown located within the cockpit of the vehicle 10 is a microphone 32A and audio speakers 32B, which together form a voice-based HMI 32. The microphone 32A is an audio input device that allows for voice speech recognition as a means to provide audio command inputs to the system. The speakers 32B are audio output devices that may include audio entertainment speakers commonly employed for audio devices in the vehicle and/or may include an audio speaker dedicated to providing voice command outputs to the passengers in the vehicle. It should be appreciated that the electronic system, and the HMIs 12 and 32 may be located at various locations within the vehicle 10. In addition, the vehicle 10 may be equipped with other HMIs, such as a visual HMI employed in front of the rear passenger seat to allow occupants in the rear seat of the vehicle 10 to interface with an entertainment system or other electronic device(s).

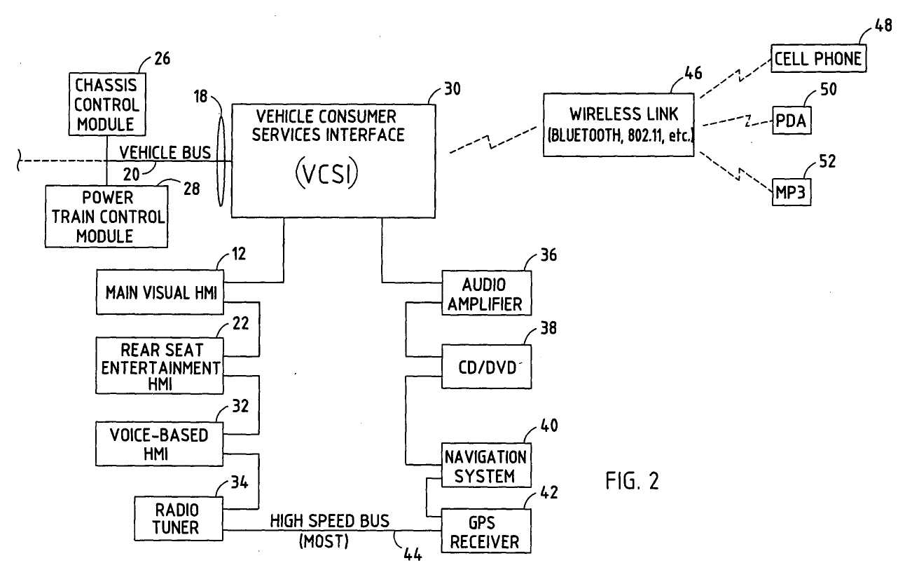

The electronic system may include one or more of a plurality of information and entertainment host devices that are generally used within the vehicle 10. An example of some electronic host devices included with an infotainment and telematics system is illustrated in FIG. 2. The electronic (e.g., infotainment) system includes various electronic host devices coupled to a vehicle consumer services interface (VCSI) host platform 30. The VCSI 30 interfaces with the various intercoupled electronic devices within the vehicle 10. VCSI host platform 30 is shown coupled to the vehicle bus 20, a high speed media oriented system transport (MOST) bus 44, and one or more wireless links 46. The vehicle bus 20 may include a conventional original equipment manufacturer (OEM) bus, such as a CAN or J1850 bus utilizing a proprietary protocol dedicated to communicating information among vehicle control devices including the chassis control module 26 and powertrain control module 28. The vehicle bus 20 is coupled to the VCSI host platform 30 via a firewall 18 which serves to shield mission critical functions from potentially harmful communications.

The VCSI host platform 30 allows various electronic host devices in the vehicle to interface with each other and to interface with the HMIs to deliver user inputs and provide user outputs. The high speed MOST bus 44 is a wire bus connected in communication with a plurality of electronic devices including the main visual HMI 12. Other HMI devices, including the rear seat entertainment HMI 22 and the voice-based HMI 32, are also connected to the high speed bus 44. Electronic host devices shown connected to bus 44 include a radio tuner 34, an audio amplifier 36, a compact disc/digital versatile disc (CD/DVD) player 38, a navigation system 40, and a global positioning system (GPS) receiver 42. The high speed MOST bus 44 allows communication between each of the electronic host devices and the VCSI host platform 30. It should be appreciated that the HMIs 12, 22, and 32 may be otherwise coupled in communication with the VCSI 30 to provide data communication between a user and the VCSI host platform 30 or between the user and any of the host devices. While the VCSI 30 is referred to herein as a host platform, it should be understood that any of the host devices (e.g, radio tuner 34, CD/DVD player 38, navigation system 40) may also operate as a host platform to execute an HMI application and to communicate data with one or more HMIs.

The VCSI 30 is further able to communicate with various wireless devices including a cell phone 48, a personal digital assistant (PDA) 50, and a media player (e.g., MP3 player) 52 via a wireless link 46. The user of any of the cell phone 48, the PDA 50, the MP3 player 52 may travel in and out of the vehicle and communicate with the vehicle via the wireless link 46. The wireless link 46 may include any of a number of wireless communication links including, but not limited to, Bluetooth and 802.11. Bluetooth provides for wireless data communication generally limited to a short range, while 802.11 provides enhanced range wireless data communication. It should be appreciated that other wire and wireless links, including long range wireless links, may be employed to provide data communication between electronic devices in the vehicle and one or more wireless communication devices. It should also be appreciated that a user may interface with any of the wireless devices (e.g., cell phone) via any of HMIs 12, 22, and 32 communicating via the VCSI host platform 30. Additionally, any of the wireless devices may also operate as a host platform to execute an HMI application and to communicate data with one or more HMIs.

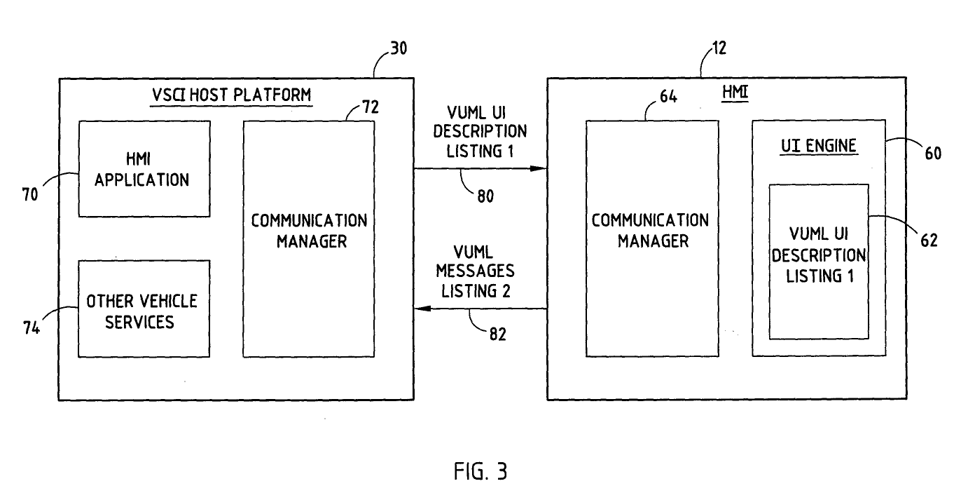

Referring to FIG. 3, the application architecture for each of the VCSI host platform 30 and HMI 12 is shown. The application architecture for HMIs 22 and 32 is the same as or similar to the application architecture employed in HMI 12 and, thus, the application architecture for HMIs 22 and 32 is not shown or discussed further in detail herein. The HMI 12 operates as a thin client having limited functionality, while the VCSI host platform 30 operates as a server that implements the remaining functionality by delivering a complete application. Thus, the HMI 12 and host platform 30 are configured in a client-server architecture. The thin client architecture of the HMI 12 is useful for vehicle applications to realize a lightweight and inexpensive user interface. The thin client architecture of the HMI 12 allows for application of an extensible markup language (XML) based user interface (UI) model to be operated in the HMI 12. Extensible markup language is the universally recognized format for structured documents and data that is well-known and widely used on the worldwide web. XML describes the class of data objects called XML documents and partially describes the behavior of computer programs which process the XML documents.

The user interface, described as an extension of XML is referred to herein as the vehicle user interface markup language (VUML). VUML is a cross-platform solution for in-vehicle application providers, which allows the user interface to be easily created, modified, and deployed, and further enables platform-neutral, dynamically reconfigurable, small footprint user interfaces for in-vehicle systems. The client-server architecture minimizes the functionality of the HMI 12 to the delivery of user inputs to the host platform and the presentation of outputs to a user. This results in enhanced flexibility of the HMI 12 and reduces cost of the in-vehicle system. In addition, use of the extended XML (VUML) for user interface description and messaging expedites the deployment of in-vehicle applications and simplifies provisioning and deployment in a vehicle.

The HMI 12 includes memory and a processor for storing and executing a user interface (UI) engine 60 including the VUML (extension of XML) user interface description 62. The user interface engine 60 executes the vehicle user interface markup language (VUML) which is a generalized user interface markup language for graphic, speech, and other user interfaces. A virtual user interface described in the VUML can be rendered as a graphic user interface, a speech user interface, or a synchronized dual user interface. The VUML provides elements for modeling the reaction of the user interface to user inputs. The VUML follows a model-view-controller (MVC) paradigm by specifying the views and the controller that accesses the model for in-vehicle services. The specification of the VUML, according to one embodiment, is disclosed herein under the heading “Vehicle User Interface Markup Language (VUML) Specification,” which describes the VUML specification for the VUML data exchange between the HMI module and the host platform. This specification is sufficient and contains enough information for a supplier of an HMI module to be able to design such a module without any additional substantive information so that the HMI module is capable of working with the host platform which understands the VUML specification.

The user interface engine 60 residing on HMI 12 may be written in an appropriate language to reduce footprint and increase performance, and may be installed by the supplier of the HMI 12. The user interface engine 60 operates as a manager of the HMI user interface. Upon receiving a user interface descriptor in VUML, the user interface engine 60 processes the user interface descriptor and generates a single or multi-model user interface based on availability of a display surface (for a visual HMI) or speech recognizer/synthesizer (for a voice-based HMI).

By following the user interface descriptor, the user interface engine 60 can handle simple user inputs, such as, for example, switching screens or constructing VUML messages that describe raw user input. For example, the user interface engine 60 can construct VUML messages that describe which input button is depressed during a user input (or which voice command is recognized), can send the VUML messages to the HMI application for processing, and can execute presentation instructions sent by the HMI application. The instructions may include displaying a text message or synthesizing a voice message for changing the user interface, etc.

The VCSI host platform 30 includes memory and a processor for storing and executing an HMI application 70, a communication manager 72, and other vehicle services 74. The HMI application 70 operates as the server to the thin client HMI 12 in that HMI application 70 implements the key application logic and access to other vehicle services. In order to map raw user inputs sent from the HMI 12 to invocations of application functions, the HMI application 70 maintains a detailed reference of the HMI user interface. The HMI application 70 can provision the VUML user interface descriptor to the HMI when it is first deployed on the VCSI host platform 30. The HMI application 70 may construct presentation instructions in response to user inputs or other system events and send such instructions to the HMI 12.

The communication manager 72 handles the sending and receiving of VUML messages on behalf of the user interface engine 60 of HMI 12. Similarly, the HMI 12 also includes a communication manager 64 for sending and receiving VUML messages on behalf of the HMI 12. The communication managers 70 and 64 may be implemented in software written in any language, as long as messages 64 and 70 are written in VUML. The other vehicle services 74 may include any of a number of vehicle services that are made available on the vehicle.

The host platform and HMI architecture of the present invention employs a VUML based communication protocol which advantageously is independent of the underlying transport protocols to communicate between the HMI application and the HMI user interface engine 60. The VUML based communication protocol may employ synchronous and asynchronous messaging. Consequently, providers of the in-vehicle application do not need any knowledge on how the HMI 12 and VCSI host platform are connected.

Referring back to FIG. 1, the display screen illustrates one example of the usage of the VUML description 80 sent to the HMI 12 in which the screen displays a telephone number “1-555-1212” and a user input “dial” button 24 for initiating a telephone call. An equivalent to the visual user interface may include a voice-based interface in which the telephone number is pronounced over text-to-speech and the command “dial” is issued by the user and recognized by a voice recognition system. In order to implement the graphic user interface as shown, the following VUML description, titled Listing 1 VUML Descriptor Program, may be employed.

Listing 1 VUML Descriptor Program

<?xml version = “1.0” encoding = “UTF-8?”>
<!DOCTYPE hmi SYSTEM
<hmi name = “example”>

<version> 1.0 </version>
<form id = “main” width = “240” top = “0” left = “0” height = “160”>

<panel>

<adaptor id = “dialTheNumber”>

<valueholder controlid = “number” type =

“equal”/>

</adaptor>
<label id = “number” left = “70” top = “35” width = “90”

height = “20” text = “15551212”/>

<button id = “dial” top = “70” left = “70” width = “75”

height = “75” height = “20” command = “Dial the Number” adaptor =
“dialTheNumber”/>

</panel>

</form>

</hmi>

The Listing 1 VUML Descriptor Program shown above is the descriptor written in VUML that describes the visual and voice-based interface. The VUML descriptor conforms to the VUML document type definition (DTD). The Listing 1 VUML Descriptor Program contains sufficient information that various VUML executed HMIs are able to generate the graphic interface as shown in FIG. 1, for example, and the equivalent respective speech user interface. It should be appreciated that the details of the user interface may be generated by the supplier of the user interface device. The Listing 1 VUML Descriptor Program contains information about the name of the controls (parameters “id”), location of the visual control (e.g., top, left, width), and also the information on what to do after the user issues a command, for example, by clicking the “dial” input button. The Listing 1 VUML Descriptor Program further contains reference to the adaptor, but not the adaptor itself. The Listing 1 Descriptor Program provides enough information to interact with the VCSI host platform 30 by way of the VUML message. In the event of multiple graphic screens or more sophisticated voice interfacing, the Listing 1 VUML Descriptor Program can be extended with more controls and additional parameters, such as navigation parameters that may be required to navigate between screens or between voice-based menus.

An example of a VUML message 82 sent by the HMI 12 to platform 30 when the “dial” input button is depressed by a user, or an equivalent voice command “dial the number” is recognized, is shown in the following VUML messages Listing 2 Program.

Listing 2 VUML Messages Program

<?xml version = “1.0” encoding = “UTF-8”?> <hmirequest>
<timestamp> 1234567 </timestamp>
<identity hmi_id = “0”/>

<screen name = “example”>

<para name = “dial” value = “15551212”> </para>

</screen>

</hmirequest>

Once the user interface is generated, a user can interact with the user interface by depressing the “dial” input button, or by speaking “dial the number” with speech recognition, which will trigger the HMI 12 to send the VUML messages as the Listing 2 VUML Messages Program. The application that is executed on the VCSI host platform 30 will then dial the telephone number provided in the message. The HMI application 70 on the VCSI host platform 30 needs to know the data and what the data means. The first task is accomplished in the Listing 2 VUML Messages Program by providing the parameter “value.” The understanding of the meaning of the data is based on the name of the control, which provides the data (parameter “name”). The application running on a VCSI host platform 30 understands the functionality behind each visual or voice-based control and can match the name of the control with the underlying functionality, since the host platform 30 originated the user interface description in the VUML.

Accordingly, the HMI enables user input and presents data output, while the functionality/algorithms applied to the data are processed in the VCSI host platform 30 such that the meaning of the data is only known to the host platform 30, in contrast to the HMI 12. In order to do so, the HMI 12 must be capable of supporting the simplest extended markup language XML parser. The HMI 12 also has to understand a definition of the document-type definition (DTD) of VUML that is generic enough to cover all possible data exchanges between the HMI 12 and the VCSI host platform 30. The document-type definition may include the HMI identity (in case of multiple HMIs), the name of the audio/visual control, and the value of this control. Accordingly, whenever there is new data that an application running on the host platform deems necessary to display, the name of the control will be sent to the HMI 12 together with the data. Similarly, when there is an input on the HMI 12 from the user, the HMI 12 will send this input to the host platform together with the name of the control.

Whenever a new HMI application is to be implemented, the HMI application should comply with the standards of the manufacturer of the host device(s)/platform. A new HMI application may be implemented as shown by routine 100 is FIG. 4. Routine 100 begins at step 102 and proceeds to decision step 104 to check if the HMI 12 is compatible with the data exchange DTD. If the HMI 12 is not compatible with the data exchange DTD, routine 100 proceeds to step 106 to download software to the HMI 12 to understand the DTD. Provided the HMI 12 is compatible with the data exchange DTD, routine 100 proceeds to create a VUML document that describes data presentation and complies with the DTD in step 108. Next, in step 110, routine 100 downloads the VUML document into both the HMI 12 and the host platform. Following step 110, routine 100 downloads the HMI application with data handling logic into the host platform in step 112, and completes the HMI application downloading in step 114.

Accordingly, the present invention allows for use of an inexpensive HMI which offers enhanced flexibility to interface with a wide variety of devices. The present application architecture advantageously enables platform-neutral, dynamically reconfigurable, small footprint user interfaces for use in vehicle systems.

### Vehicle User Interface Markup Language (VUML) Specification

The specification of the VUML, according to one embodiment, will now be described below according to one example for VUML data exchange between the HMI module and the host platform. The specification is illustrated using content model diagrams shown in FIGS. 4-25 and further attributes are presented in the tables below. The specification includes the following element types present in the Element Types Table and Attribute Types Table.

ELEMENT TYPES TABLE

| D | Type | Content | Content Model | Attributes |
|---|---|---|---|---|
| E | hmiapp | Elements | (version, form*, | name, top, left, width, height, |
| | | | formgroup*) | icon, background |
| E | version | Text | | |
| E | form | Elements | (panel+) | height, top, width, left, visible, |
| | | | | name |
| E | panel | Elements | (label*, button*, | name, icon, visible, background, |
| | | | buttongroup*, | top, left, width, height |
| | | | toggledbutton*, list*, table*, | |
| | | | clock*, audiolevel*, | |
| | | | calendar*, combo*, | |
| | | | messageboard*, | |
| | | | speechindicator*, | |
| | | | fanspeedindicator*, | |
| | | | volumeindicator*, panel*) | |
| E | button | Elements | (listener*, valuesource*) | link, command, response, |
| | | | | grammar, pressedicon, |
| | | | | selectedicon, rollovericon, |
| | | | | action, value, disabledicon, |
| | | | | toggle, text, font, icon, |
| | | | | fontmetrics, fontstyle, |
| | | | | background, foreground, |
| | | | | alignmentX, alignmentY, |
| | | | | %commonAttributes |
| E | toggledbutton | Elements | (listener*, valuesource*) | %commonAttributes, |
| | | | | presscommand, releasecommand, |
| | | | | pressedicon, selectedicon, |
| | | | | rollovericon, pressaction, |
| | | | | releaseaction, pressvalue, |
| | | | | releasevalue, pressvalueSource, |
| | | | | releasevalueSource, text, font, |
| | | | | icon, fontmetrics, fontstyle, |
| | | | | background, foreground, |
| | | | | alignmentX, alignmentY |
| E | buttongroup | Elements | (button+) | name, selected |
| E | label | EMPTY | | text, font, icon, fontmetrics, |
| | | | | fontstyle, background, |
| | | | | foreground, alignmentX, |
| | | | | alignmentY, %commonAttributes |
| E | list | Elements | (item*) | type, text, font, icon, |
| | | | | fontmetrics, fontstyle, |
| | | | | background, foreground, |
| | | | | alignmentX, alignmentY, |
| | | | | %commonAttributes |
| E | table | Elements | (row*) | text, font, fontmetrics, fontstyle, |
| | | | | background, foreground, |
| | | | | alignmentX, alignmentY, |
| | | | | %commonAttributes |
| E | item | Text | | |
| E | row | Elements | (colume*) | |
| E | colume | Text | | font, fontmetrics, border, |
| | | | | background, foreground, |
| | | | | alignmentX, alignmentY |
| E | header | Elements | (colume*) | |
| E | listener | EMPTY | | name, type |
| E | valuesource | EMPTY | | name, type |
| E | clock | EMPTY | | type, font, timezone, |
| | | | | %commonAttributes |
| E | audiolevel | EMPTY | | value, icon, %commonAttributes |
| E | formgroup | Elements | (form+) | top, left, width, height, visible |
| E | combo | Elements | (item*) | text, font, fontmetrics, fontstyle, |
| | | | | background, foreground, |
| | | | | alignmentX, alignmentY, |
| | | | | %commonAttributes |
| E | messageboard | EMPTY | | text, font, fontmetrics, fontstyle, |
| | | | | background, foreground, |
| | | | | alignmentX, alignmentY, |
| | | | | %commonAttributes |
| E | speechindicator | EMPTY | | %commonAttributes |
| E | fanspeedindicator | EMPTY | | %commonAttributes |
| E | calendar | EMPTY | | %commonAttributes |

ATTRIBUTES TYPES TABLE

| Attribute Name | Element | Data Type | Use |
|---|---|---|---|
| action | button | string | optional |
| alignmentX | shared (8) | string | optional |
| alignmentY | shared (8) | string | optional |
| background | shared (10) | string | optional |
| border | colume | string | optional |
| command | button | string | optional |
| disabledicon | button | string | optional |
| font | shared (9) | string | optional |
| fontmetrics | shared (8) | string | optional |
| fontstyle | shared (7) | string | optional |
| foreground | shared (8) | string | optional |
| grammar | button | string | optional |
| height | shared (5) | string | optional |
| icon | shared (7) | string | optional |
| left | shared (5) | string | optional |
| link | button | string | optional |
| name | shared (8) | id | required |
| pressaction | toggledbutton | string | optional |
| presscommand | toggledbutton | string | optional |
| pressedicon | shared (2) | string | optional |
| pressvalue | toggledbutton | string | optional |
| pressvalueSource | toggledbutton | string | optional |
| releaseaction | toggledbutton | string | optional |
| releasecommand | toggledbutton | string | optional |
| releasevalue | toggledbutton | string | optional |
| releasevalueSource | toggledbutton | string | optional |
| response | button | string | optional |
| rollovericon | shared (2) | string | optional |
| selected | buttongroup | string | optional |
| selectedicon | shared (2) | string | optional |
| text | shared (7) | string | optional |
| timezone | clock | string | optional |
| toggle | button | string | optional |
| top | shared (5) | string | optional |
| type | shared (5) | string | optional |
| value | shared (2) | string | optional |
| visible | shared (4) | string | optional |
| width | shared (5) | string | optional |

General entities internal and external, parameter entitles internal and external, notations, and processing instructions are presented below, followed by a source text computer program.

GENERAL ENTITIES INTERNAL

| | |
|---|---|
| Name | Value |

GENERAL ENTITIES EXTERNAL

| | | | |
|---|---|---|---|
| Name | System (e.g. File or | Public Name | Notation |
| | URL) | | |

PARAMETER ENTITIES INTERNAL

| Name | Value |
|---|---|
| CommonAttributes | name ID #REQUIRED top CDATA #IMPLIED left |
| | CDATA #IMPLIED width CDATA #IMPLIED |
| | height CDATA #IMPLIED visible CDATA |
| | #IMPLIED |

PARAMETER ENTITIES EXTERNAL

| | | | |
|---|---|---|---|
| Name | System (e.g. File or URL) | Public Name | Include in DTD |

NOTATIONS

| | | |
|---|---|---|
| Name | Location (e.g. File or URL) | Public Name |

PROCESSING INSTRUCTIONS

| | |
|---|---|
| Target | Instruction |

SOURCE TEXT

<?xml version=‘1.0’ encoding=‘UTF-8’?>
<!--Generated by Turbo XML 2.3.1.100.-->
<!ENTITY%commonAttributes “name ID #REQUIRED
top CDATA #IMPLIED
left CDATA #IMPLIED
width CDATA #IMPLIED
height CDATA #IMPLIED
visible CDATA #IMPLIED”>
<!ELEMENT hmiapp (version, form*, formgroup*)>
<!ATTLIST hmiapp name ID #REQUIRED
top CDATA #IMPLIED
left CDATA #IMPLIED
width CDATA #IMPLIED
height CDATA #IMPLIED
icon CDATA #IMPLIED
background CDATA #IMPLIED>
<!ELEMENT version (#PCDATA)>
<!ELEMENT form (panel + |dialog *)>
<!ATTLIST form height CDATA #IMPLIED
top CDATA #IMPLIED
width CDATA #IMPLIED
left CDATA #IMPLIED
visible CDATA #IMPLIED
name ID #REQUIRED>
<!ELEMENT panel (label*, button*, buttongroup*, toggledbutton*, list*, table*, clock*,
audiolevel*, calendar*, combo*, messageboard*, speechindicator*, fanspeedindicator*,
volumeindicator*, panel*)>
<!ATTLIST panel name ID #REQUIRED
icon CDATA #IMPLIED
visible CDATA #IMPLIED
background CDATA #IMPLIED
top CDATA #IMPLIED
left CDATA #IMPLIED
width CDATA #IMPLIED
height CDATA #IMPLIED
<!ELEMENT button (listener*, valuesource*)>
<!ATTLIST button link CDATA #IMPLIED
command CDATA #IMPLIED
response CDATA #IMPLIED
grammar CDATA #IMPLIED
pressedicon CDATA #IMPLIED
selectedicon CDATA #IMPLIED
rollovericon CDATA #IMPLIED
action CDATA #IMPLIED
value CDATA #IMPLIED
disabledicon CDATA #IMPLIED
toggle CDATA #IMPLIED
text CDATA #IMPLIED
font CDATA #IMPLIED
icon CDATA #IMPLIED
fontmetrics CDATA #IMPLIED
fontstyle CDATA #IMPLIED
background CDATA #IMPLIED
foreground CDATA #IMPLIED
alignmentX CDATA #IMPLIED
alignmentY CDATA #IMPLIED
%commonAttributes;>
<!ELEMENT toggledbutton (listener*, valuesource*)>
<!ATTLIST toggledbutton %commonAttributes;
presscommand CDATA #IMPLIED
releasecommand CDATA #IMPLIED
pressedicon CDATA #IMPLIED
selectedicon CDATA #IMPLIED
rollovericon CDATA #IMPLIED
pressaction CDATA #IMPLIED
releaseaction CDATA #IMPLIED
pressvalue CDATA #IMPLIED
releasevalue CDATA #IMPLIED
pressvalueSource CDATA #IMPLIED
releasevalueSource CDATA #IMPLIED
text CDATA #IMPLIED
font CDATA #IMPLIED
icon CDATA #IMPLIED
fontmetrics CDATA #IMPLIED
fontstyle CDATA #IMPLIED
background CDATA #IMPLIED
foreground CDATA #IMPLIED
alignmentX CDATA #IMPLIED
alignmentY CDATA #IMPLIED
<!ELEMENT buttongroup (button+)>
<!ATTLIST buttongroup name ID #REQUIRED
selected CDATA #IMPLIED>
<!ELEMENT label EMPTY>
<!ATTLIST label text CDATA #IMPLIED
font CDATA #IMPLIED
icon CDATA #IMPLIED
fontmetrics CDATA #IMPLIED
fontstyle CDATA #IMPLIED
background CDATA #IMPLIED
foreground CDATA #IMPLIED
alignmentX CDATA #IMPLIED
alignmentY CDATA #IMPLIED
%commonAttributes;>
<!ELEMENT list (item*)>
<!ATTLIST list type CDATA #IMPLIED
text CDATA #IMPLIED
font CDATA #IMPLIED
icon CDATA #IMPLIED
fontmetrics CDATA #IMPLIED
fontstyle CDATA #IMPLIED
background CDATA #IMPLIED
foreground CDATA #IMPLIED
alignmentX CDATA #IMPLIED
alignmentY CDATA #IMPLIED
%commonAttributes;>
<!ELEMENT table (row*)>
<!ATTLIST table text CDATA #IMPLIED
font CDATA #IMPLIED
fontmetrics CDATA #IMPLIED
fontstyle CDATA #IMPLIED
background CDATA #IMPLIED
foreground CDATA #IMPLIED
alignmentX CDATA #IMPLIED
alignmentY CDATA #IMPLIED
%commonAttributes;>
<!ELEMENT dialog (panel+)>
<!ATTLIST dialog name ID #REQUIRED
voiceprompt CDATA #IMPLIED>
<!ELEMENT item (#PCDATA)>
<!ELEMENT row (colume*)>
<!ELEMENT colume (#PCDATA)>
<!ATTLIST colume font CDATA #IMPLIED
fontmetrics CDATA #IMPLIED
border CDATA #IMPLIED
background CDATA #IMPLIED
foreground CDATA #IMPLIED
aligmnentX CDATA #IMPLIED
alignmentY CDATA #IMPLIED
<!ELEMENT header (colume*)>
<!ELEMENT listener EMPTY>
<!ATTLIST listener name ID #REQUIRED
type CDATA #IMPLIED>
<!ELEMENT valuesource EMPTY>
<!ATTLIST valuesource name ID #REQUIRED
type CDATA #IMPLIED>
<!ELEMENT clock EMPTY>
<!ATTLIST clock type CDATA #IMPLIED
font CDATA #IMPLIED
timezone CDATA #IMPLIED
%commonAttributes;>
<!ELEMENT audiolevel EMPTY>
<!ATTLIST audiolevel value CDATA #IMPLIED
icon CDATA #IMPLIED
%commonAttributes;>
<!ELEMENT formgroup (form+)>
<!ATTLIST formgroup top CDATA #IMPLIED
left CDATA #IMPLIED
width CDATA #IMPLIED
height CDATA #IMPLIED
visible CDATA #IMPLIED
<!ELEMENT combo (item*)>
<!ATTLIST combo text CDATA #IMPLIED
font CDATA #IMPLIED
fontmetrics CDATA #IMPLIED
fontstyle CDATA #IMPLIED
background CDATA #IMPLIED
foreground CDATA #IMPLIED
alignmentX CDATA #IMPLIED
alignmentY CDATA #IMPLIED
%commonAttributes;>
<!ELEMENT messageboard EMPTY>
<!ATTLIST messageboard text CDATA #IMPLIED
font CDATA #IMPLIED
fontmetrics CDATA #IMPLIED
fontstyle CDATA #IMPLIED
background CDATA #IMPLIED
foreground CDATA #IMPLIED
alignmentX CDATA #IMPLIED
alignmentY CDATA #IMPLIED
%commonAttributes;>
<!ELEMENT speechindicator EMPTY>
<!ATTLIST speechindicator %commonAttributes;>
<!ELEMENT volumeindicator EMPTY>
<!ATTLIST volumeindicator type CDATA #IMPLIED
%commonAttributes;>
<!ELEMENT fanspeedindicator EMPTY>
<!ATTLIST fanspeedindicator %commonAttributes;>
<!ELEMENT calendar EMPTY>
<!ATTLIST calendar %commonAttributes;>

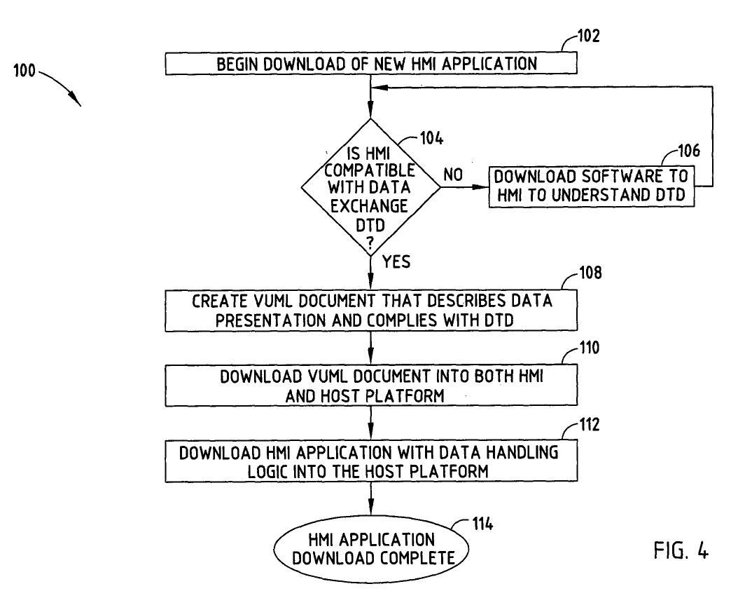

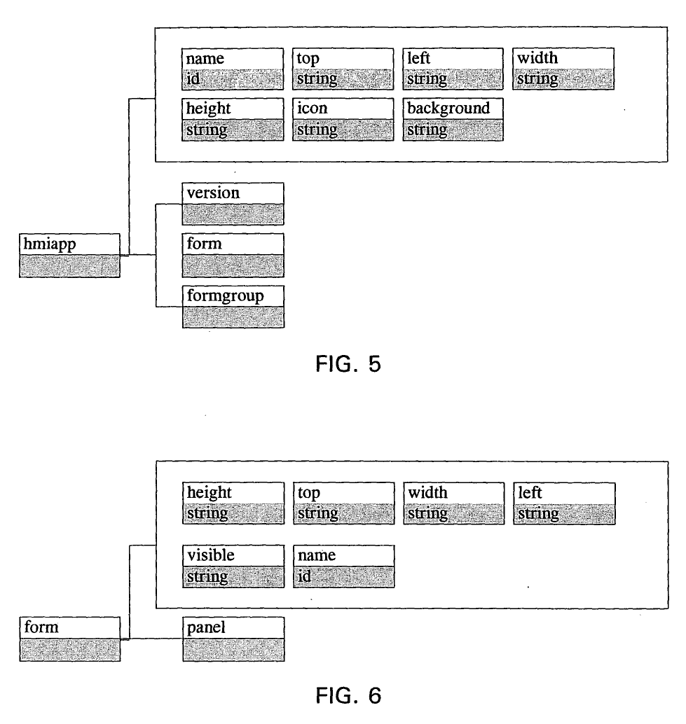

The content model diagrams of the VUML specification are shown in FIGS. 5-25. Referring to FIG. 5, the HMIAPP content model is illustrated therein. The HMIAPP content model is the root tag of the VUML descriptor. The HMIAPP content model contains a version element and optional form and form group elements as seen by its further attributes presented in the following table labeled HMIAPP table below.

HMIAPP TABLE

| Attribute | Type | Use | Description |
|---|---|---|---|
| name | ID | Required | identifier of this |
| | | | application |
| top | String | Optional | top position of the |
| | | | application (in pixels) |
| left | String | Optional | left position of the |
| | | | application (in pixels) |
| width | String | Optional | width of the application (in |
| | | | pixels) |
| height | String | Optional | height of the application |
| | | | (in pixels) |
| icon | String | Optional | background image file |
| | | | path or URL |
| background | String | Optional | background color |

The content model labeled VERSION is for tracking different additions of the same user interface.

The content model labeled FORM is illustrated in FIG. 6. The content model FORM is the top container of all control panels. Further attributes of the content model FORM are presented in the following table labeled FORM Table.

FORM TABLE

| Attribute | Type | Use | Description |
|---|---|---|---|
| name | ID | Required | identifier of this form |
| top | String | Optional | top position of the form (in |
| | | | pixels) |
| left | String | Optional | left position of the form (in |
| | | | pixels) |
| width | String | Optional | width of the form (in pixels) |
| height | String | Optional | height of the form (in pixels) |
| visible | String | Optional | if it is “false,” the form is |
| | | | invisible |

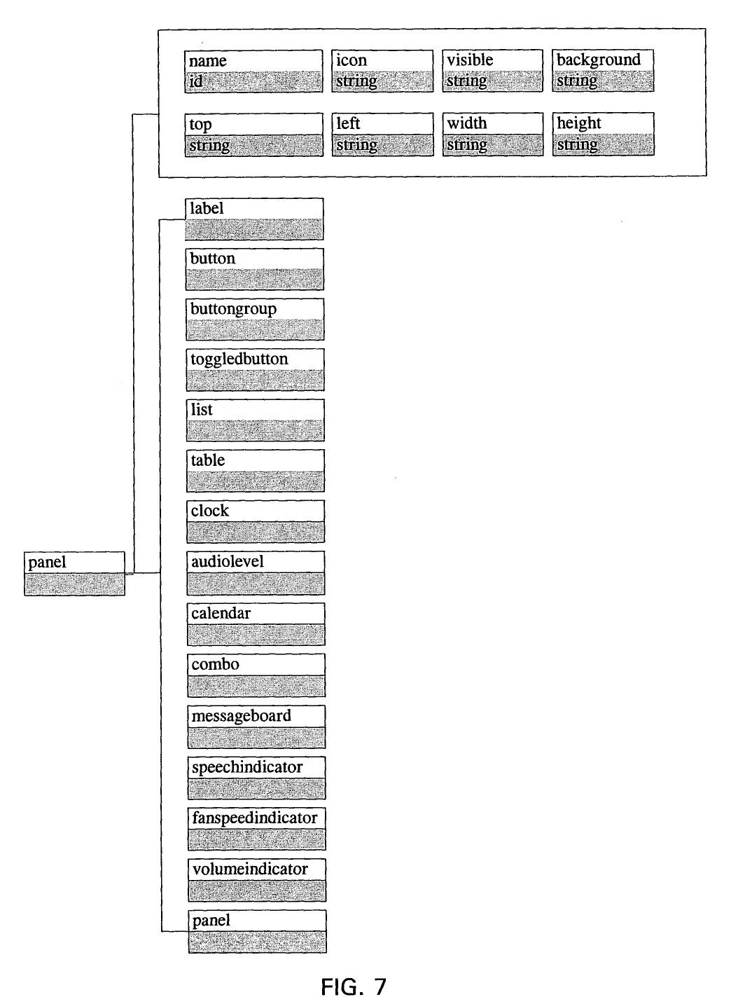

The content model PANEL is illustrated in FIG. 7. The content model PANEL is the sub-container of all controls. The content model PANEL facilitates the visual layout of controls, and can be nested. Further attributes of the content model PANEL are illustrated in the following table labeled PANEL Table.

PANEL TABLE

| Attribute | Type | Use | Description |
|---|---|---|---|
| name | ID | Required | identifier of this panel |
| top | String | Optional | top position of the panel |
| | | | (in pixels) |
| left | String | Optional | left position of the panel |
| | | | (in pixels) |
| width | String | Optional | width of the panel (in |
| | | | pixels) |
| height | String | Optional | height of the panel (in |
| | | | pixels) |
| icon | String | Optional | background image file |
| | | | path or URL |
| background | String | Optional | background color of the |
| | | | panel. Ignored if Icon is |
| | | | defined |
| visible | String | Optional | if it is “false,” the panel is |
| | | | invisible |

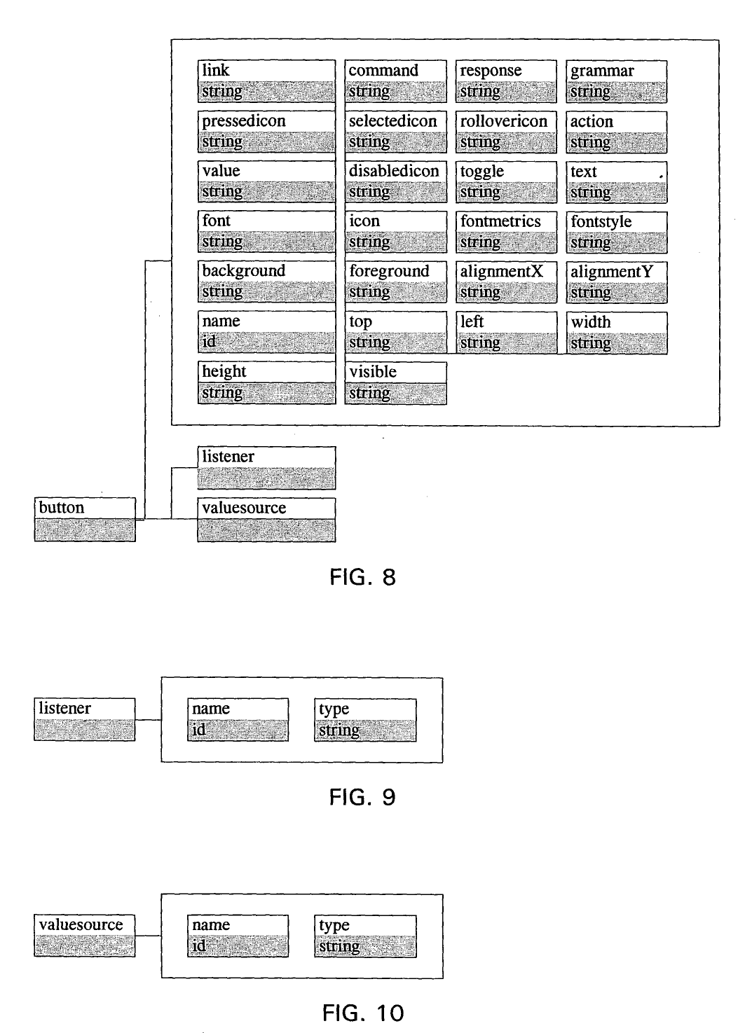

The content model BUTTON is illustrated in FIG. 8. The content model BUTTON is a user interface control. Action is performed when the button is pushed or the voice command (e.g., command attribute) is recognized. An action can be any of the following: (1) sending an XML message that contains its “value” attribute or the “value” attribute of the embedded “valuesource” elements to VCSI if “action” equals to true; (2) switching to the form or bringing up the dialog that identified by “link” attribute; and (3) triggering actions in the embedded “listener” elements.

Further attributes of the BUTTON content model are illustrated in the following table labeled BUTTON Table.

BUTTON TABLE

| Attribute | Type | Use | Description |
|---|---|---|---|
| name | ID | Required | identifier of this button |
| top | String | Optional | top position of the button |
| left | String | Optional | left position of the button |
| width | String | Optional | width of the button |
| height | String | Optional | height of the button |
| text | String | Optional | text displayed on the button. Ignored |
| | | | if one of the icons is defined. |
| value | String | Optional | value represented by the button |
| font | String | Optional | font of the text |
| fontmetrics | String | Optional | font size of the text |
| background | String | Optional | background color of the button |
| foreground | String | Optional | foreground color of the button |
| alignmentX | String | Optional | horizontal alignment of the text |
| alignmentY | String | Optional | vertical alignment of the text |
| icon | String | Optional | default Icon file path or URL |
| link | String | Optional | form or dialog name |
| command | String | Optional | single voice command. Ignored if |
| | | | “grammar” is defined |
| pressedicon | String | Optional | icon file path or URL when the |
| | | | button is pressed |
| selectedicon | String | Optional | icon file path or URL when the |
| | | | button is selected |
| rollovericon | String | Optional | icon file path or URL when the |
| | | | button is rolled over |
| action | String | Optional | if “true,” triggers XML message sent |
| | | | to VCSI |
| grammar | String | Optional | speech recognition grammar |
| | | | conforms to Java Speech API |
| response | String | Optional | speech response |
| fontstyle | String | Optional | font style |

The content model LISTENER is illustrated in FIG. 9. The content model LISTENER is an observer that will be notified when a button is pushed, a voice command is recognized or a toggled button's status is changed when an item is selected inside a combo. Listeners are enclosed inside a BUTTON element or a TOGGLEDBUTTON or a COMBO. “Name” attribute identifies the affected control. “Type” attribute identifies how the value of the control is affected. If “type” equals “reset,” the control's value is reset. If “type” equals “replace,” the control's value is replaced with the enclosing button's value. If “type” equals “append,” the control's value is appended with the enclosing button's value. If “type” equals “visible,” the control is set visible. If “type” equals “invisible,” the control is set hidden.

The content model VALUESOURCE is illustrated in FIG. 10. The content model VALUSOURCE identifies the controls whose values will be sent to the VCSI when the enclosing control is activated. The attributes of the content model VALUESOURCE are further illustrated in the following table labeled VALUESOURCE Table.

VALUESOURCE TABLE

| Attribute | Type | Use | Description |
|---|---|---|---|
| name | ID | Required | identifier of a control |
| type | String | Optional | undefined |

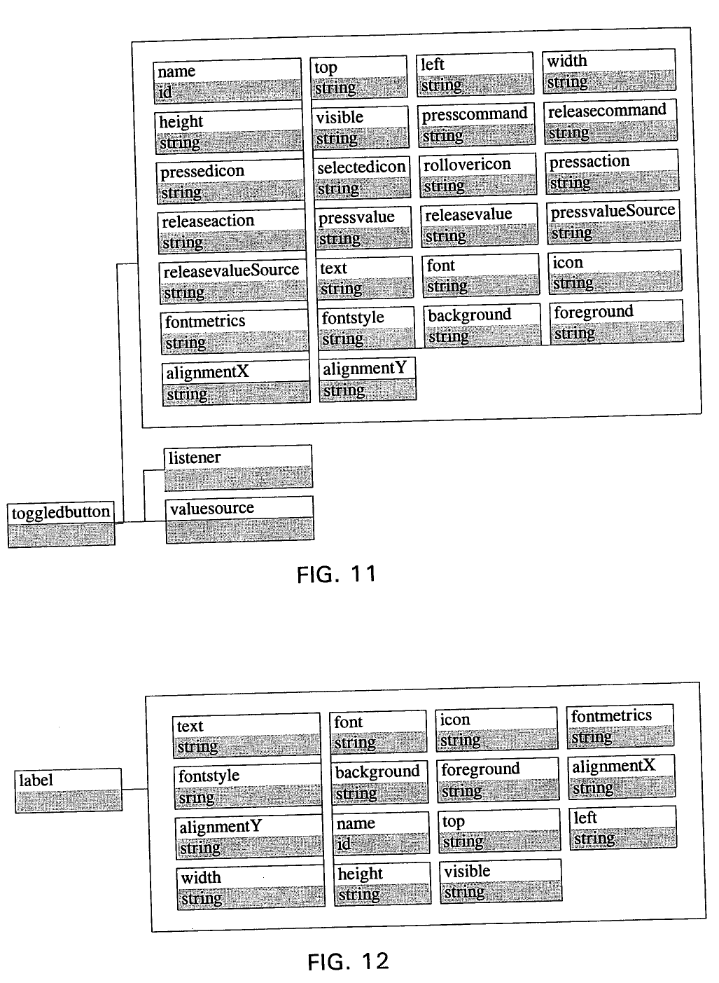

The content model TOGGLEDBUTTON is illustrated in FIG. 11. The content model TOGGLEDBUTTON is a user interface (UI) control. An action is performed when the button is pushed or released or the voice command (e.g. releasecommand or presscommand attribute) is recognized. An action can be: (1) sending an XML message that contains “value” or the “value” attribute of the embedded “valuesource” elements to VCSI if “pressaction” or “releaseaction” equals to true; or (2) triggering actions in the button's listeners.

The attributes of the content model TOGGLEDBUTTON are further illustrated in the following table labeled TOGGLEDBUTTON Table.

TOGGLEDBUTTON TABLE

| Attribute | Type | Use | Description |
|---|---|---|---|
| name | ID | Required | identifier of this button |
| top | String | Optional | top position of the button |
| left | String | Optional | left position of the button |
| width | String | Optional | width of the button |
| height | String | Optional | height of the button |
| text | String | Optional | text displayed on the button |
| pressvalue | String | Optional | value represented by the pressed |
| | | | button |
| font | String | Optional | font of the text |
| fontmetrics | String | Optional | font size of the text |
| background | String | Optional | background color of the button |
| foreground | String | Optional | foreground color of the button |
| alignmentX | String | Optional | horizontal alignment of the text |
| alignmentY | String | Optional | vertical alignment of the text |
| pressaction | String | Optional | if “true,” sends XML message |
| | | | when it is pressed |
| releaseaction | String | Optional | if “true,” sends XML message |
| | | | when it is released |
| releasecommand | String | Optional | voice command |
| pressedicon | String | Optional | icon file path or URL when the |
| | | | button is pressed |
| selectedicon | String | Optional | icon file path or URL when the |
| | | | button is selected |
| rollovericon | String | Optional | icon file path or URL when the |
| | | | button is rolled over |
| releasevalue | String | Optional | value represented by the released |
| | | | button |
| presscommand | String | Optional | voice command |
| visible | String | Optional | if “false,” the control is set |
| | | | invisible |
| fontstyle | String | Optional | font style |

The content model LABEL is illustrated in FIG. 12. The content model LABEL is a user interface control that displays image and/or text. Further attributes of the content model LABEL are illustrated in the following table labeled LABEL Table.

LABEL TABLE

| Attribute | Type | Use | Description |
|---|---|---|---|
| name | ID | Required | identifier of this label |
| top | String | Optional | top position of the label |
| left | String | Optional | left position of the label |
| width | String | Optional | width of the label |
| height | String | Optional | height of the label |
| text | String | Optional | text displayed on the label |
| font | String | Optional | font of the text |
| fontmetrics | String | Optional | font size of the text |
| icon | String | Optional | icon file path or URL |
| background | String | Optional | background color of the label |
| foreground | String | Optional | foreground color of the label |
| alignmentX | String | Optional | horizontal alignment of the text |
| alignmentY | String | Optional | vertical alignment of the text |
| fontstyle | String | Optional | font style |
| visible | String | Optional | if “false,” the control is set invisible |

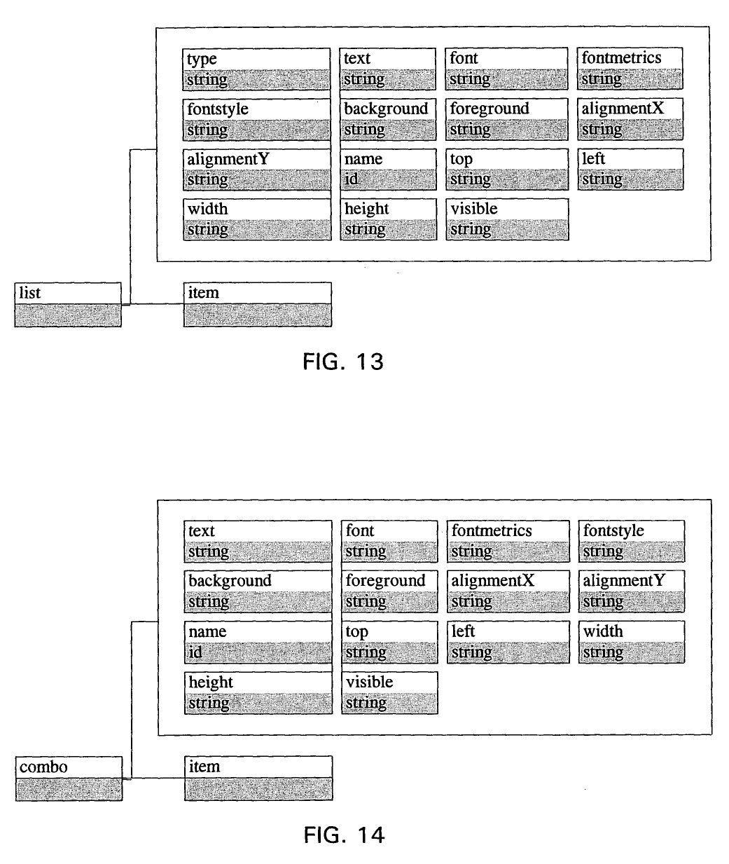

The content model LIST is illustrated in FIG. 13. The content model LIST is a visual control that displays multiple text items. Further attributes of the content model LIST are illustrated in the following table labeled LIST Table.

LIST TABLE

| Attribute | Type | Use | Description |
|---|---|---|---|
| name | ID | Required | identifier of this control |
| top | String | Optional | top position of the control |
| left | String | Optional | left position of the control |
| width | String | Optional | width of the control |
| height | String | Optional | height of the control |
| text | String | Optional | default selection |
| font | String | Optional | font of the text |
| fontmetrics | String | Optional | font size of the text |
| background | String | Optional | Background color of the control |
| foreground | String | Optional | foreground color of the control |
| alignmentX | String | Optional | horizontal alignment of the text |
| alignmentY | String | Optional | vertical alignment of the text |
| fontstyle | String | Optional | font style |
| visible | String | Optional | if “false,” the control is set invisible |

The content model ITEM encapsulates a string of text.

The content model COMBO is illustrated in FIG. 14. The content model COMBO is similar to the content model list, except it only displays one item at a time. Further attributes of the content model COMBO are illustrated in the following table labeled COMBO Table.

COMBO TABLE

| Attribute | Type | Use | Description |
|---|---|---|---|
| name | ID | Required | identifier of this control |
| top | String | Optional | top position of the control |
| left | String | Optional | left position of the control |
| width | String | Optional | width of the control |
| height | String | Optional | height of the control |
| text | String | Optional | text displayed on the control |
| font | String | Optional | font of the text |
| fontmetrics | String | Optional | font size of the text |
| background | String | Optional | background color of the control |
| foreground | String | Optional | foreground color of the control |
| alignmentX | String | Optional | horizontal alignment of the text |
| alignmentY | String | Optional | vertical alignment of the text |
| fontstyle | String | Optional | font style |
| visible | String | Optional | if “false,” the control is set invisible |

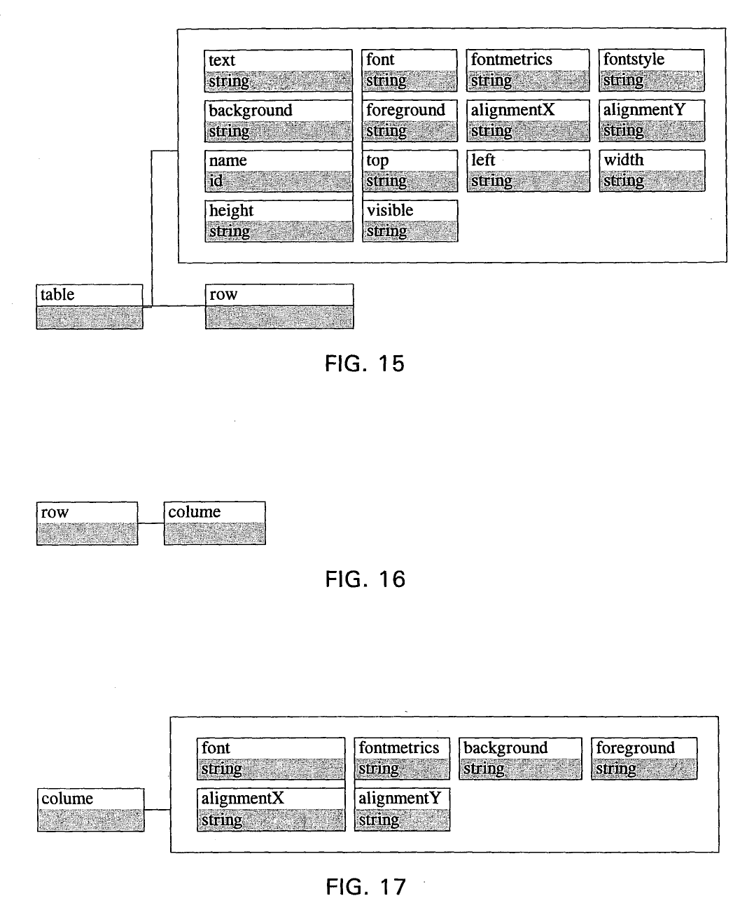

The content model TABLE is illustrated in FIG. 15. The content model TABLE is a visual control that displays two-dimensional data. Further attributes of the content model TABLE are illustrated in the following table labeled TABLE Table.

TABLE TABLE

| Attribute | Type | Use | Description |
|---|---|---|---|
| name | ID | Required | identifier of this control |
| top | String | Optional | top position of the control |
| left | String | Optional | left position of the control |
| width | String | Optional | width of the control |
| height | String | Optional | height of the control |
| text | String | Optional | text displayed on the control |
| font | String | Optional | font of the text |
| fontmetrics | String | Optional | font size of the text |
| background | String | Optional | background color of the control |
| foreground | String | Optional | foreground color of the control |
| alignmentX | String | Optional | horizontal alignment of the text |
| alignmentY | String | Optional | vertical alignment of the text |
| fontstyle | String | Optional | font style |
| visible | String | Optional | if “false,” the control is set invisible |

The content model ROW is illustrated in FIG. 16. The content model ROW encapsulates a table row.

The content model COLUME is illustrated in FIG. 17. The content model COLUME represents a table cell. Further attributes of the content model COLUME are illustrated in the following table labeled COLUME Table.

COLUME TABLE

| Attribute | Type | Use | Description |
|---|---|---|---|
| font | String | Optional | font of the text |
| fontmetrics | String | Optional | font size of the text |
| background | String | Optional | background color of the colume |
| foreground | String | Optional | foreground color of the colume |
| alignmentX | String | Optional | horizontal alignment of the text |
| alignmentY | String | Optional | vertical alignment of the text |

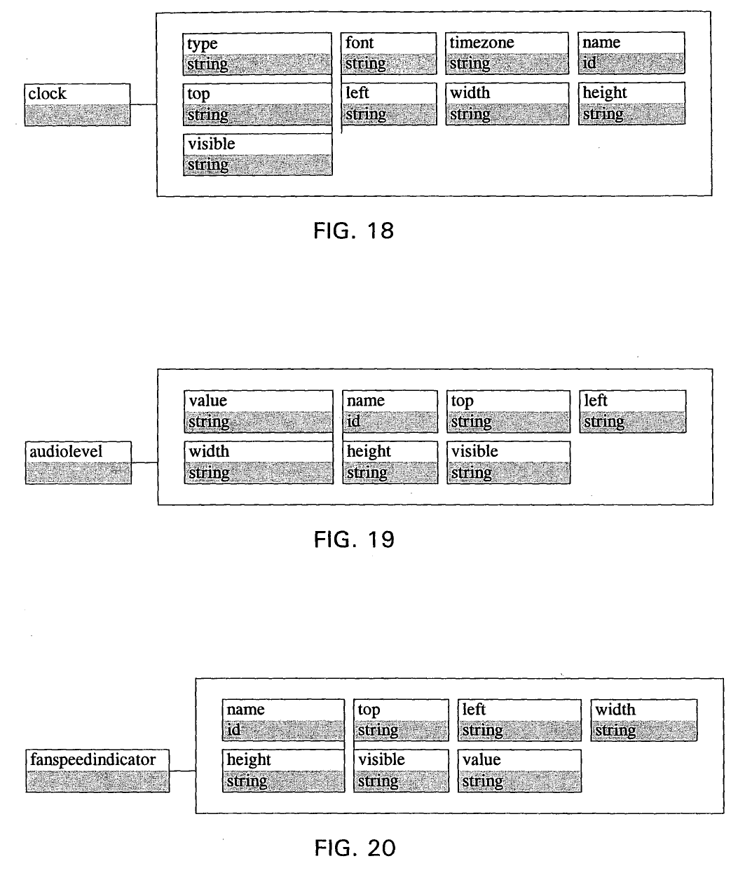

The content model CLOCK is illustrated in FIG. 18. The content model CLOCK is a visual control that displays current time of day. Further attributes of the content model CLOCK are illustrated in the following table labeled CLOCK Table.

CLOCK TABLE

| Attribute | Type | Use | Description |
|---|---|---|---|
| name | ID | Required | identifier of this control |
| top | String | Optional | top position of the control |
| left | String | Optional | left position of the control |
| width | String | Optional | width of the control |
| height | String | Optional | height of the control |
| type | String | Optional | “digital” or “analog” |
| timezone | String | Optional | GMT +/− HOURS |
| font | String | Optional | font name if type is “digital” |
| visible | String | Optional | if “false,” the control is set invisible |

The content model AUDIOLEVEL is illustrated in FIG. 19. The content model AUDIOLEVEL is a level control that displays audio level. Further attributes of the content model AUDIOLEVEL are illustrated in the following table labeled AUDIOLEVEL Table.

AUDIOLEVEL TABLE

| Attribute | Type | Use | Description |
|---|---|---|---|
| name | ID | Required | identifier of this control |
| top | String | Optional | top position of the control |
| left | String | Optional | left position of the control |
| width | String | Optional | width of the control |
| height | String | Optional | height of the control |
| value | String | Optional | the value of the audio level |
| visible | String | Optional | if “false,” the control is set invisible |

The content model FANSPEEDINDICATOR is illustrated in FIG. 20. The content model FANSPEEDINDICATOR is a visual control that displays fan speed. Further attributes of the content model FANSPEEDINDICATOR are illustrated in the following table labeled FANSPEEDINDICATOR Table.

FANSPEEDINDICATOR TABLE

| Attribute | Type | Use | Description |
|---|---|---|---|
| name | ID | Required | identifier of this control |
| top | String | Optional | top position of the control |
| left | String | Optional | left position of the control |
| width | String | Optional | width of the control |
| height | String | Optional | height of the control |
| value | String | Optional | the value of the fan speed |
| visible | String | Optional | if “false,” the control is set invisible |

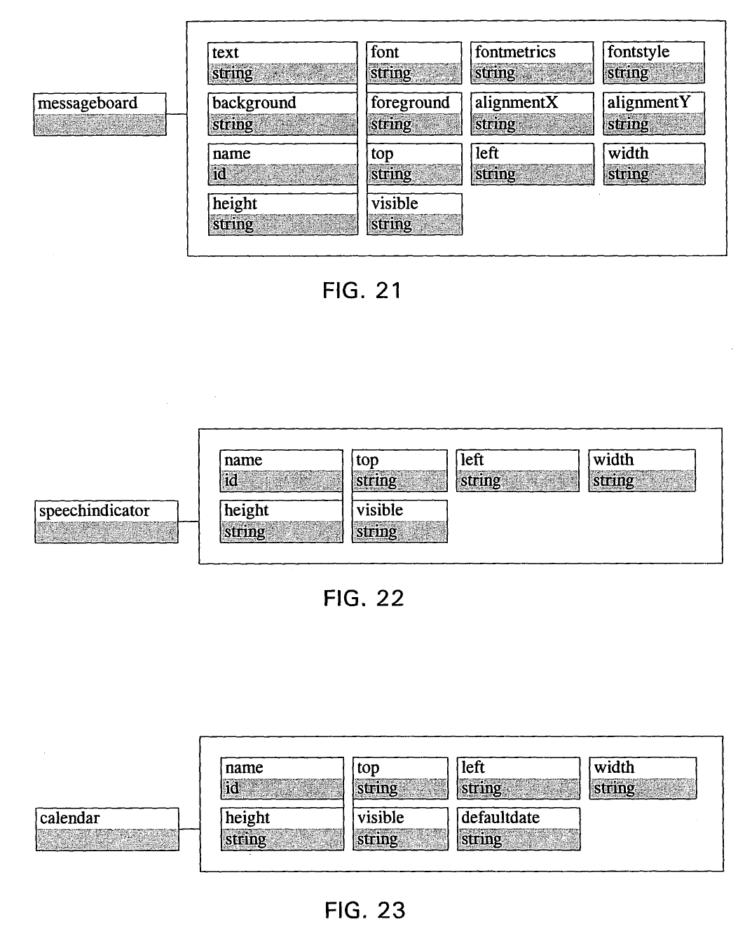

The content model MESSAGEBOARD is illustrated in FIG. 21. The content model MESSAGEBOARD presents system prompts or feedback to the user by displaying text message or using TTS. Further attributes of the content model MESSAGEBOARD are illustrated in the following table labeled MESSAGEBOARD Table.

MESSAGEBOARD TABLE

| Attribute | Type | Use | Description |
|---|---|---|---|
| name | ID | Required | identifier of this control |
| top | String | Optional | top position of the control |
| left | String | Optional | left position of the control |
| width | String | Optional | width of the control |
| height | String | Optional | height of the control |
| text | String | Optional | text displayed on the control |
| font | String | Optional | font of the text |
| fontmetrics | String | Optional | font size of the text |
| background | String | Optional | background color of the control |
| foreground | String | Optional | foreground color of the control |
| alignmentX | String | Optional | horizontal alignment of the control |
| aligmnentY | String | Optional | vertical alignment of the control |
| fontstyle | String | Optional | font style |
| visible | String | Optional | if “false,” the control is set invisible |

The content model SPEECHINDICATOR is illustrated in FIG. 22. The content model SPEECHINDICATOR displays current status of the speech engine. Further attributes of the content model SPEECHINDICATOR are illustrated in the following table labeled SPEECHINDICATOR Table.

SPEECHINDICATOR TABLE

| Attribute | Type | Use | Description |
|---|---|---|---|
| name | ID | Required | identifier of this control |
| top | String | Optional | top position of the control |
| left | String | Optional | left position of the control |
| width | String | Optional | width of the control |
| height | String | Optional | height of the control |
| visible | String | Optional | if “false,” the control is set invisible |

The content model CALENDAR is illustrated in FIG. 23. The content model CALENDAR displays appointment information by day, week, month, or year. Further attributes of the content model CALENDAR are illustrated in the following table labeled CALENDAR Table.

CALENDAR TABLE

| Attribute | Type | Use | Description |
|---|---|---|---|
| name | ID | Required | identifier of this control |
| top | String | Optional | top position of the control |
| left | String | Optional | left position of the control |
| width | String | Optional | width of the control |
| height | String | Optional | height of the control |
| visible | String | Optional | if “false,” the control is set invisible |
| defaultdate | String | Optional | initial date |

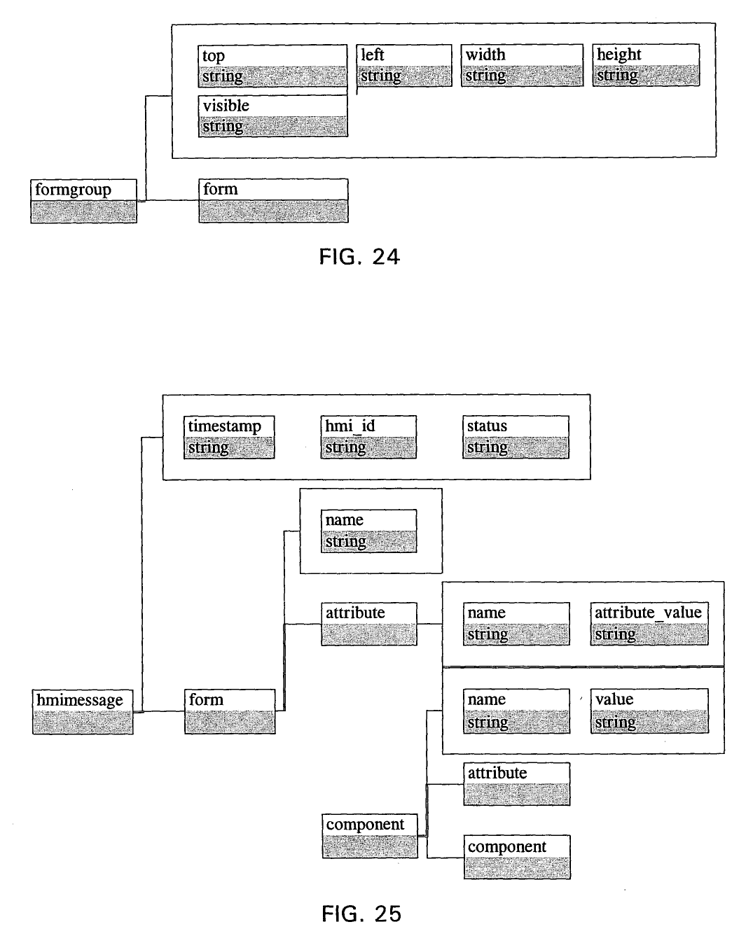

The content model FORMGROUP is illustrated in FIG. 24. The content model FORMGROUP is a logical control, of which only one of its enclosed forms can be displayed at a time. Further attributes of the content model FORMGROUP are illustrated in the following table labeled FORMGROUP Table.

FORMGROUP TABLE

| Attribute | Type | Use | Description |
|---|---|---|---|
| name | ID | Required | identifier of this control |
| top | String | Optional | top position of the control |
| left | String | Optional | left position of the control |
| width | String | Optional | width of the control |
| height | String | Optional | height of the control |
| visible | String | Optional | if “false,” the control is set invisible |

The VUML language specification includes a VUML messaging specification. The VUML messaging specification is shown in the content model diagram of FIG. 25. The VUML messaging specification includes the following Element Types Table, Attribute Types Table, and Source Text Computer Program.

ELEMENT TYPES TABLE

| | | | Content | |
|---|---|---|---|---|
| D | Type | Content | Model | Attributes |
| E | hmimessage | Elements | (form*) | timestamp, hmi_id, status |
| E | attribute | EMPTY | | name, attribute_value |
| E | component | Elements | (attribute*, | name, value |
| | | | component*) | |
| E | form | Elements | (attribute*, | name |
| | | | component*) | |

ATTRIBUTE TYPES TABLE

| Attribute Name | Element | Data Type | Use |
|---|---|---|---|
| attribute_value | attribute | string | required |
| hmi_id | hmimessage | string | optional |
| name | shared (3) | string | required |
| status | hmimessage | string | optional |
| timestamp | hmimessage | string | optional |
| value | component | string | optional |

SOURCE TEXT

<?xml version=‘1.0’ encoding=‘UTF-8’?>
<!--Generated by Turbo XML 2.3.1.100.-->
<!ELEMENT hmimessage (form*)>
<!ATTLIST hmimessage timestamp CDATA #IMPLIED
hmi_id CDATA #IMPLIED
status CDATA #IMPLIED>
<!ELEMENT attribute EMPTY>
<!ATTLIST attribute name CDATA #REQUIRED
attribute_value CDATA #REQUIRED>
<!ELEMENT component (attribute*, component*)>
<!ATTLIST component name CDATA #REQUIRED
value CDATA #IMPLIED>
<!ELEMENT form (attribute*, component*)>
<!ATTLIST form name CDATA #REQUIRED>

The content model HMIMESSAGE is the root tag of the VUML message. The content model HMIMESSAGE contains zero or more form elements. The enclosed message can be created by the HMI and sent to the VCSI or vice versa. Attributes of the content model HMIMESSAGE are illustrated in the following table labeled HMIMESSAGE Table.

HMIMESSAGE TABLE

| Attribute | Type | Use | Description |
|---|---|---|---|
| timestamp | String | Optional | time when the message is |
| | | | generated |
| hmi-id | String | Required | uniquely identify the HMI |
| | | | that sends or receives the |
| | | | message |
| status | String | Optional | TBD |

The content model FORM maps the FORM tag in VUML specification, which is the top container of all controls. The content model FORM encloses ATTRIBUTE and COMPONENT elements. Attributes of the content model FORM are illustrated in the following table labeled FORM Table.

FORM TABLE

| Attribute | Type | Use | Description |
|---|---|---|---|
| name | String | Required | The name of the form |
| | | | where the components |
| | | | reside. |

If the content model ATTRIBUTE is enclosed in the content model FORM, its attributes are defined in the following table labeled ATTRIBUTE FORM Table.

ATTRIBUTE FORM TABLE

| Attribute | Type | Use | Description |
|---|---|---|---|
| name | String | Required | The name of the VUML |
| | | | FORM attribute. It can be |
| | | | one of the following: top, |
| | | | left, width, height, visible |
| attribute_value | String | Required | New value of this attribute |

If the content model ATTRIBUTE is enclosed in the content model COMPONENT, its attributes are defined in the following table labeled ATTRIBUTE COMPONENT Table.

ATTRIBUTE COMPONENT TABLE

| Attribute | Type | Use | Description |
|---|---|---|---|
| name | String | Required | The name of the VUML |
| | | | control attribute |
| attribute_value | String | Required | New value of this attribute |

The content model COMPONENT is the generic representation of all VUML controls. The content model COMPONENT can be nested to describe controls that can contain other controls, e.g., list, table, etc. Attributes of the content model COMPONENT are illustrated in the following table labeled COMPONENT Table.

COMPONENT TABLE

| Attribute | Type | Use | Description |
|---|---|---|---|
| name | String | Required | The name of the VUML |
| | | | control. |
| value | String | Required | The value of this control. |

In connection with the VUML specification described above, all VUML messages may begin with the following header. CONTENT_TYPE=Xml and CONTENT_LENGTH=<length of the VUML message>

In connection with the above-described VUML specification example, the following should also be noted. The Only BUTTON and TOGGLEDBUTTON may be allowed to fire messages from HMI to VCSI, if their “Action” attribute is set “True.” LIST and COMBO may be enabled to fire messages. The actual content of the message is controlled by the user interface descriptor written in VUML. The message includes the name of the enclosing Form element, the name of the Button element, the name and value of the Button element's enclosed Valuesource elements if any.

### EXAMPLE 1

In the following user interface (UI) descriptor, if BUTTON “b_phone_end” which does not have an enclosed Valuesource element is pressed,

<?xml version = “1.0” encoding = “UTF-8”?>
<hmiapp name = “test” top = “0” left = “0” width = “640” height = “480” >

<version> 1.0 </version>

<form name = “Phone” height = “420” top = “60” width “640” left = “0” >

<button name = “b_phone_end” top = “250” left = “390” width = “67”

height = “67” icon = “b_phone_end.gif” pressedicon = “b_phone_end_down.gif”
rollovericon = “b_phone_end_over.gif” action = “true” command = “hangup”/>

</form>

</hmiapp>

### EXAMPLE 2

In the following user interface (UI) descriptor, if BUTTON “b_phone_send” that has an enclosed Valuesource element is pressed,

<?xml version = “1.0” encoding = “UTF-8”?>
<hmiapp name = “test” top = “0” left = “0” width = “640” height = “480”>

<version> 1.0 </version>

<form name = “Phone” height = “420” top = “60” width = “640” left = “0”>
<label name = “1_number” top = “10” left = “2” width = “200” height = “60”
foreground = “red” text = “13135551212”/>

<button name = “b_phone_send” top = “250” left = “41” width = “67” height

= “67” icon = “b_phone_send.gif” pressedicon = “b_phone_send_down.gif”
rollovericon = “b_phone_send_over.gif” action = “true”>

<valuesource name = 1_number”/>

</button>

</form>

</hmiapp>

The following message is sent to VCSI:

CONTENT_TYPE = Xml

CONTENT_LENGTH = <length of the following XML document>
<?xml version = “1.0” encoding = “UTF-8”?>
<hmimessage hmi_id = “0” timestamp = “1234567”>
<form name = “Phone”>
<component name = “b_phone_send”>

<component name = “1_number” value = “13135551212”/>

</component>
</form>
</hmimessage>

Further, in connection with the above-described VUML specification example, messages sent from the VCSI to HMI set VUML control's attributes with new values. As a result, the user interface changes accordingly.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

The invention claimed is:

1. A user interfacing electronics system for use in a vehicle comprising:
a host platform having application software for executing an application for an electronic device;
a human machine interface for receiving user inputs and providing outputs to a user;
a data communication link for communicating data between the host platform and the human machine interface; and
user interface markup language for communicating messages on the communication link between the host platform and human machine interface, including messages to deliver user inputs and outputs.

2. The system as defined in claim 1, wherein the host platform comprises an electronic device.

3. The system as defined in claim 1, wherein the host platform comprises an interface device coupled between the human machine interface and an electronic device.

4. The system as defined in claim 1, wherein the human machine interface comprises a display.

5. The system as defined in claim 1, wherein the human machine interface comprises an audio input device and an audio output device.

6. The system as defined in claim 1, wherein the markup language comprises an extension of extensible markup language (XML).

7. A method of communicating data between a human machine interface and a host platform in a vehicle, said method comprising the steps of:
generating a first message comprising markup language in the host platform;
communicating the first message comprising markup language from the host platform to a human machine interface to provide an output to a user on the human machine interface;
communicating a second message comprising markup language from the human machine interface to the host platform to deliver user inputs entered into the human machine interface; and
processing the second message with application software provided in the host platform.

8. The method as defined in claim 7, wherein the host platform comprises an electronic device.

9. The method as defined in claim 7, wherein the host platform comprises an interface device coupled between the human machine interface and an electronic device.

10. The method as defined in claim 7 further comprising the step of displaying the output to a user on a display.

11. The method as defined in claim 7 further comprising the step of broadcasting the output via audio sound and receiving user inputs via speech recognition.

12. The method as defined in claim 7, wherein the step of generating the first message comprises an extension of extensible markup language (XML).
